(19) United States
(12) Patent Application Publication
(10) Pub. No.: US 2012/0137200 A1
(43) Pub. Date: May 31, 2012

(54) SYSTEM AND METHOD FOR DISPLAYING ELECTRONIC PUBLICATIONS

(76) Inventors: JONATHAN SHAR, New York, NY (US); Roger Webster, San Martin, CA (US); Matt Pallakoff, Mountain View, CA (US); Ravi Gopalakrishnan, San Jose, CA (US)

(21) Appl. No.: 13/282,409

(22) Filed: Oct. 26, 2011

Related U.S. Application Data
(60) Provisional application No. 61/406,975, filed on Oct. 26, 2010.

(51) Int. Cl. G06F 17/00

(52) U.S. Cl. 715/202; 715/204

(57) ABSTRACT

A file format and a reader for electronic periodicals composed a digital replica of a hardcopy of a periodical. The file format includes a plurality of primarily text-only files corresponding to articles in the digital replica. The reader displays the digital replica, and when a user activates a control to select an article, a separate view is displayed that displays the text only version of the selected article. In this view the text of the article appears linearly, from beginning to end, and is presented as a continuous, sequential text file.

### CROSS REFERENCE TO RELATED APPLICATION

This application claims benefit under 35 U.S.C. §119(e) from U.S. Provisional Patent application No. 61/406,975, filed on Oct. 26, 2010, the entirety of which is incorporated by reference herein.

### FIELD OF THE INVENTION

The present invention generally relates to electronic readers, e-readers, and more particularly to electronic readers for displaying digital publications.

### BACKGROUND OF THE INVENTION

The present generation of digital periodical readers typically displays only page-replica versions of digital periodicals, including, but not limited to, digital versions of magazines like Time™, newspapers such as the Wall Street Journal™, or academic publications such as Nature™. In this page replica representation, the pages displayed on the reader look and behave very similarly to the hard copy representations, and fail to take advantage of the flexibility of such presentations in the digital domain. Although some readers allow for interaction with certain portions of the content on a replica page, e.g., graphics or video, none of them allow for presentation and navigation of the textual content of articles contained on the replica pages. When an article is clicked on, tapped, touched in the digital replica of the periodical or in the Table of Contents, a replica version of the article is presented to the user.

### SUMMARY OF THE INVENTION

The present invention overcomes the limitations of traditional readers by taking advantage of elements in the electronic publication that hold document elements, which may include but are not limited to videos, images, graphics, audio clips, etc., a description of the replica page in terms of its constituent elements and the geometric relationships between these elements as they are laid out on the page. Significantly, the present invention utilizes text-only files in the electronic publication for all document elements that contain any text, e.g., articles in a magazine. These text-only descriptive files are generally referred to as meta-information or meta-data file, and can be instantiated in a multiplicity of ways.

The present invention is a system and method for deploying a digital periodical reader user interface that can present a primary text-only view that is overlaid in the foreground on top of a page replica view of the article as it appears in its hard-copy version. The system and method of the present invention is dynamic in the sense that it adapts to the page layout and offers a variety of different views to users to accommodate their preferences, on a page-by-page basis, with a range of granularity greatly exceeding that which is available from conventional readers.

In the present invention, this capability is enabled by mapping a meta-data file to an internal representation of each page, as contained in that file, to regions of the screen as defined by a set of bounding polygons, and then associating gestures or touches within those boundaries with a variety of system behaviors and presentations from which a user can select.

An alternative method of providing similar support not involving the “bounding polygon” approach is the use of a touch-button-activated drop-down menu that includes of list of articles, as depicted in a page-replica view, that begin on a certain page and are available to the user in the text-only view.

Irrespective of the manner of presentation, any article, even when presented in text view, may be accompanied by one or more illustrations, which can be photos, graphics, etc.

In its preferred implementation, the current invention is intended to work in conjunction with appropriate operating systems, middleware and application software necessary to support a touch-sensitive display and interaction sub-systems.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a typical replica page with various text and pictorial elements that together comprise numerous articles;

FIG. 2 illustrates the ArticleView™ of the text of an article selected from the replica view;

FIG. 3 shows a drop-down menu that appears when the user touches the ArticleView™ button on the digital reader upper navigation bar;

FIG. 4 depicts the state of the user interface when the user selects a different article from the drop-down list; and

FIG. 5 depicts an exemplary electronic reader of the present invention.

### DETAILED DESCRIPTION OF THE INVENTION

The format of the electronic publications of the present invention for digital replica content addresses the need for a file format that allows for fluid user interactions, e.g., page-turns, with content derived from press-ready PDFs, while also allowing the textual content of the content to be easily read. This format is hereinafter referred to as “DRP.”

A DRP electronic publication is essentially an ePub publication. It is a zip file with the normal ePub structure, including an Open Packaging Format, OPF, with a manifest, spine, etc. Fundamentally, a DRP contains two categories of items: images of pages rasterized from the incoming PDF from a publisher, and the text and images, if desired, of articles contained in the publication, preferably formatted in XHTML. There are several important ways in which a DRP deviates from the ePub standard. The format of the DRP and the reading system of the present invention allow images to be top-level items in the spine. Further, the DRP adds a replica map, described below, that maps page images to XHTML content and vice versa. In the ArticleView™ state of the present invention, the system presents the text of an article plus a headline, byline and one or more images in an HTML view. Preferably, the article displayed in the ArticleView™ “floats” above the replica page image, with some of the underlying page image visible along the sides of the article view.

While full-page images can be spine items, the preferred implementation of DRP files does not place images as spine items. Rather, the spine items are the articles, such that if a user opens a DRP with a conventional ePub reader, the user navigates through the articles, not the full-page replica images of the content.

An important aspect to the DRP format is the replica map. The replica map contains information that indicates which articles are on which pages, page-images, of the content. This mapping is bi-directional, so there are two ways for a user to navigate through the content of a publication. The user can navigate on an article-by-article basis, in the ArticleView™, or on a page-by-page basis in a replica view. Whichever view is used, the pages and the articles stay in sync. Additionally, a page with one or more articles causes a User Interface, UI, element, e.g., a button, to appear at the top of the screen of the reader device which, when pressed, either opens the article viewer, in the case where there is only one article on the current page, or displays a list of articles, in the case where there is more than one article, or article fragment, on the current page.

The replica map is a simple structure that contains spatial information. The spatial information describes rectangles on a page where articles, or parts of articles, reside. The values are in the range of [0 . . . 1], where zero is the top/left, and one is bottom/right. That is, [0, 0, 1, 1] represents the entire page, while [0.5, 0.5, 1, 1] represents the bottom-right quadrant of the page. The notion used here is essentially identical to the HTML <map> tag, except that the coordinates are expressed as fractions of page width and height, rather than as absolute values. This allows the image to be zoomed and retain the coordinate mapping.

The primary purpose of the ArticleView™ is to solve the problem when the text too small or too cumbersome to read in the replica view, even when viewing a page at full zoom. Content as rendered in the DRP is not tailored for any specific device, but rather is created with print output as the primary medium. The ArticleView™ of the present invention allows users to select fonts and point sizes as in a typical ePub reader.

The DRP format of the present invention comprises a file containing all assets needed by the periodical reader and reader application. The basis for this file is a standard electronic publications file with additions supporting the special functionality of the current invention. Specifically, every page in the page-replica version of the electronic publication exists in the periodical reader package as pre-rendered image, thus not requiring the page to be rendered or formatted before it can be viewed. Further, all text based articles in the publication have corresponding text-only based files that include only the text of the article and perhaps one image at the beginning of the text to assist in identifying the article.

In addition, the preferred implementation includes a meta-data file encoded in .xml that describes the page order, which thumbnail image should be used for a given page, and a reference to one or more groups of blocks.

Groups are identified in the replica map by the “<Group>” tag, and block elements by the <Block> tag. Each group corresponds to the locations on a page spanned by a single article. Articles blocks may be not be contiguous. There may be multiple articles, represented by multiple <Group> elements, per page.

A block contains four values identifying where on the page the block/article fragment is located. These values range from 0 to 1, and are fractions applied to the vertical and horizontal dimensions of the page, as rendered, to derive x and y offsets, preferably in pixels, from the top-left corner of the page. These values may then be used to map touch events to a particular article or article fragment.

Groups are used by the reader application to present the list of articles on a given page. Each group contains a reference to an XML file describing the article. An “article.xml” file referenced as an attribute of a group via “ePubTarget” contains the text only content of the article, along with additional data for next/previous article links, header information, etc. Note that the markup in the article is used to identify the “hero image” that is presented as part of the article in article mode. As implemented, this image “slides in” as an effect has part of moving to a particular article.

The replica map is processed by the periodical reader application to construct data structures enabling navigation, article mode on appropriate pages, as identified by the presence of one or more Group tags, and a scrubber, via the per-page thumbnails. Article XML files are consumed by the reader application, enabling it to present visually pleasing article text plus images, and quickly navigate to other articles on the same or different pages.

Below is an example replicaMap.xml file, including page definitions.

<?xml version=“1.0” encoding=“UTF-8”?>
<ReplicaMap xmlns=“http://www.hp.com/schemas/imaging/ereader/hff”>

<Title>O, The Oprah Magazine, 01 September 2010</Title>
<Pages>

<Page pageNum=“0” file=“images/pages/pg-01.jpg”

thumbFile=“images/pages/pg-01-thumb.jpg”>

<Group ePubTarget=“article_1-1.xml”/>

</Page>
<Page pageNum=“1” file=“images/pages/pg-02.jpg”

thumbFile=“images/pages/pg-02-thumb.jpg”/>

<Page pageNum=“2” file=“images/pages/pg-03.jpg”

thumbFile=“images/pages/pg-03-thumb.jpg”/>

...
<Page pageNum=“21” file=“images/pages/pg-22.jpg”

thumbFile=“images/pages/pg-22-thumb.jpg”>

<Group ePubTarget=“article_22-1.xml”>

<Block coord=“0.159265,0.1424,0.400579,0.1728”/>
<Block
coord=“0.121622,0.176801,0.444016,0.228801”/>
<Block coord=“0.282819,0.2384,0.469113,0.4984”/>

</Group>
<Group ePubTarget=“article_22-2.xml”>

<Block
coord=“0.173745,0.059199,0.527992,0.118399”/>
<Block
coord=“0.49083,0.166801,0.610521,0.181601”/>
<Block
coord=“0.482625,0.3176,0.690637,0.619199”/>

</Group>
<Group ePubTarget=“article_22-3.xml”>

<Block
coord=“0.17471,0.054801,0.520753,0.116401”/>
<Block
coord=“0.701738,0.166801,0.828186,0.182801”/>
<Block
coord=“0.695946,0.3164,0.927606,0.624801”/>

</Group>
<Group ePubTarget=“article_22-4.xml”>

<Block coord=“0.17471,0.058,0.517856,0.1148”/>
<Block
coord=“0.492278,0.686801,0.666023,0.702801”/>
<Block
coord=“0.693532,0.640801,0.912645,0.943601”/>
<Block
coord=“0.880792,0.9176,0.908301,0.9404”/>

</Group>

</Page>

There may be multiple “Group” elements per page, one per distinct article, and zero or more Block elements per Group element. The Block element defines a rectangle, as described above that contains all or part of a particular article. The “pageNum” attribute is the value to be displayed if any page numbers are shown in the user interface.

Following the <Pages> section is the <Articles> section. Below is an example <Articles> section.

<?xml version=″1.0″ encoding=″UTF-8″?>
<!DOCTYPE html
PUBLIC ″-//W3C//DTD XHTML 1.1//EN″
″http://www.w3.org/TR/xhtml11/DTD/xhtml11.dtd″>
<html xmlns:saxon=″http://saxon.sf.net/″
xmlns=″http://www.w3.org/1999/xhtml″

xmlns:nitf=″http://www.nytimes.com/applicationdata/xml/nitf-3-3.dtd″>

<head>

<title>Defending Your Rights</title>
<link rel=″stylesheet″ href=″css/TablesAndFloats.css″ type=″text/css″/>

</head>
<body>

<div id=″header_navbar″ class=″articleMenuWrapper″>

<span id=″header_navbar_previous″ class=″sectionMenuLeft″>

<a href=″article_30-1.xml″>Previous Article</a>

</span>
<span id=″header_navbar_next″ class=″sectionMenuRight″>

<a href=″article_30-3.xml″>Next Article</a>

</span>

</div>
<div class=″clean″/>
<div id=″header″ class=″masthead″>

<div class=″masthead-text″>

<div id=″header_title″ class=″masthead-section″>

<a href=″section_1.xml″>General</a>

</div>

</div>

</div>
<h2 id=″headline″ class=″article-full-headline″>Defending Your

Rights</h2>

<p id=″byline″ class=″article-full-byline″></p>
<div>

<div id=″image_0″ class=″article-in-image″>

<img id=″image_0_img″ class=″article-in-image″

src=″images/img_7_30-2-1.jpg″ alt=″News image″/>

<div id=″image_0_credit″ class=″articleImageCredit″>COURTESY OF

BRENDA SCHERLOSKI.</div>

</div>
<p xmlns:xhtml=″http://www.w3.org/1999/xhtml″ class=″article-full-

body″>As an avid reader with great respect for O, I was disappointed that “O's
Declaration of Reader Independence” [July] included a right to ignore memoirs
written by the barely 30 set. It reminds me of my ex-agent's reply after I told
him my memoir covered the year before I turned 30: “Did you have kidney
disease or something?” Or what my writing teacher said the first day of grad
school: “Unless you were lucky enough to make out with your father, you don't
have a story to tell.” I'm troubled by this belief that memoirists must meet an
age requirement to be worthy—and it seems counter to O's integrity.</p>

<p xmlns:xhtml=″http://www.w3.org/1999/xhtml″ class=″article-full-

body″>SUZANNE GUILLETTE</p>

<p xmlns:xhtml=″http://www.w3.org/1999/xhtml″ class=″article-full-

body″>New York City</p>

<p xmlns:xhtml=″http://www.w3.org/1999/xhtml″ class=″article-full-

body″>I would like to add an item to “O's Declaration of Reader
Independence”: I also declare my right to start a book by reading the ending—
either the last page or the last chapter.</p>

<p xmlns:xhtml=″http://www.w3.org/1999/xhtml″ class=″article-full-

body″>CAROL LUNDGREN</p>

<p xmlns:xhtml=″http://www.w3.org/1999/xhtml″ class=″article-full-

body″>Sheridan, Wyoming</p>

<div id=″footer_navbar″ class=″sectionMenuWrapper″>

<span id=″footer_navbar_previous″ class=″sectionMenuLeft″>

<a href=″article_30-1.xml″>Previous Article</a>

</span>
<span id=″footer_navbar_next″ class=″sectionMenuRight″>

<a href=″article_30-3.xml″>Next Article</a>

</span>

</div>

</div>

</body>

</html>

Following the <Articles> section is the <TOC> section. Below is an example <TOC> section.

<TOC>

<TocEntry title=“Cover”>

<Summary>Cover</Summary>
<Page pagenum=“0”/>

</TocEntry>

...

<TocEntry title=“BIG HEADLINE”>

<Summary>A short summary of the article goes here.

Use it wisely.</Summary>

<Page pagenum=“9”/>
<Article refid=“a-174286635”/>

</TocEntry>

The TOC in a DRP contains information beyond the standard <navItem> entries in a typical NCX file (page number and summary).

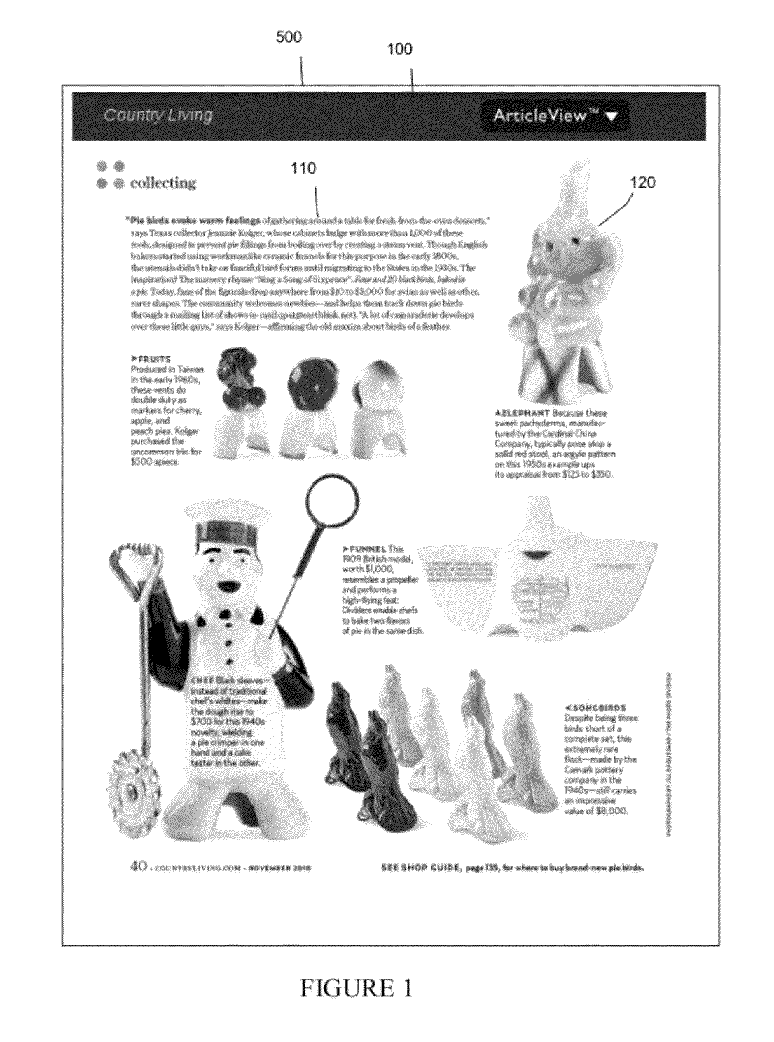

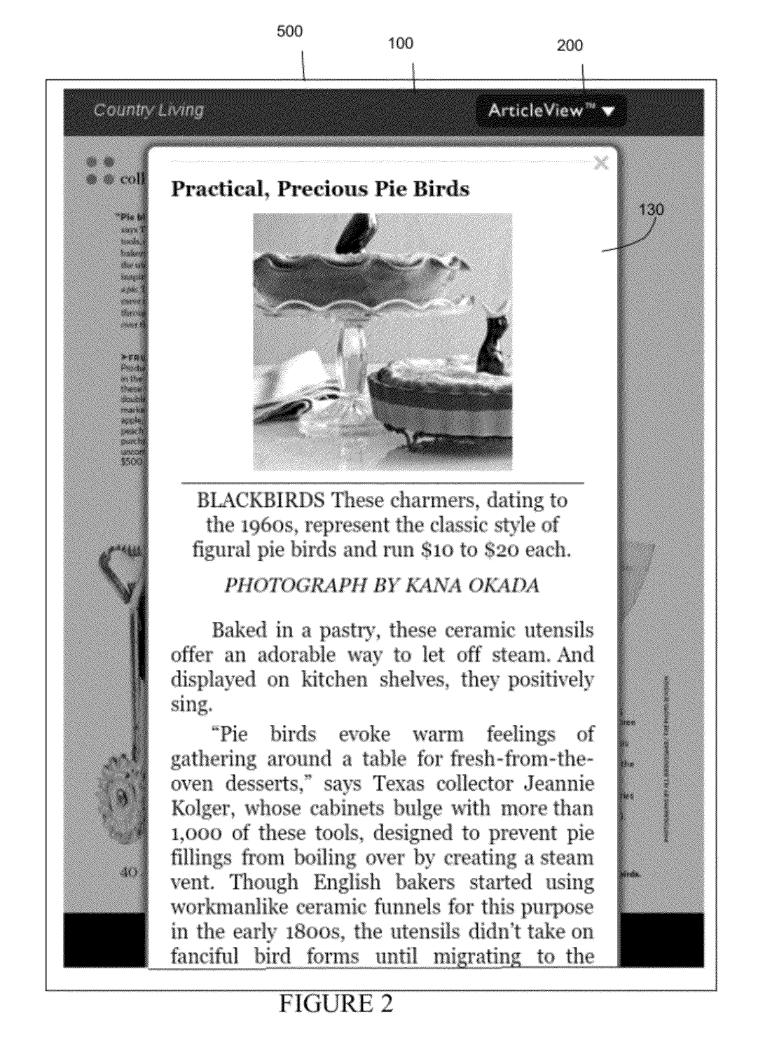

FIG. 1 illustrates a UI screen 100 of an electronic reader device 500 incorporating the present invention. The publication illustrated in FIG. 1 is being viewed in the replica view. As seen in this Figure, the replica view includes both text 110 and graphics 120 as would be seen in a printed copy of the of the publication. A user, while reading/viewing the replica view of the periodical, is able to tap on the replica view text 110 of the article and bring up the text-only file in a separate ArticleView™ 130 for easier reading of the text of the article as illustrated in FIG. 2. The ArticleView™ 130 of an article in the periodical is opened in a separate window, layered on top of the replica view of the periodical. The user is able to scroll through the entire article using conventional navigation methods, e.g., a down swipe scrolls down, an up swipe scrolls up.

The present invention allows a user to access multiple articles/text items on an individual replica page and go directly to that individual item in ArticleView™ This allows a user to toggle into the ArticleView™ to read the specific content from a replica page that they were interested in, versus just reading the content found on a replica page. None of the prior art periodical readers allow a user to decide which article/caption/or text item from an individual replica page to read in a text only ArticleView™. When users of the reader of the present invention are viewing the replica view of a periodical and tap on that article to isolate the article for reading, the prior art readers simply present another replica view of that article, not a text-only view.

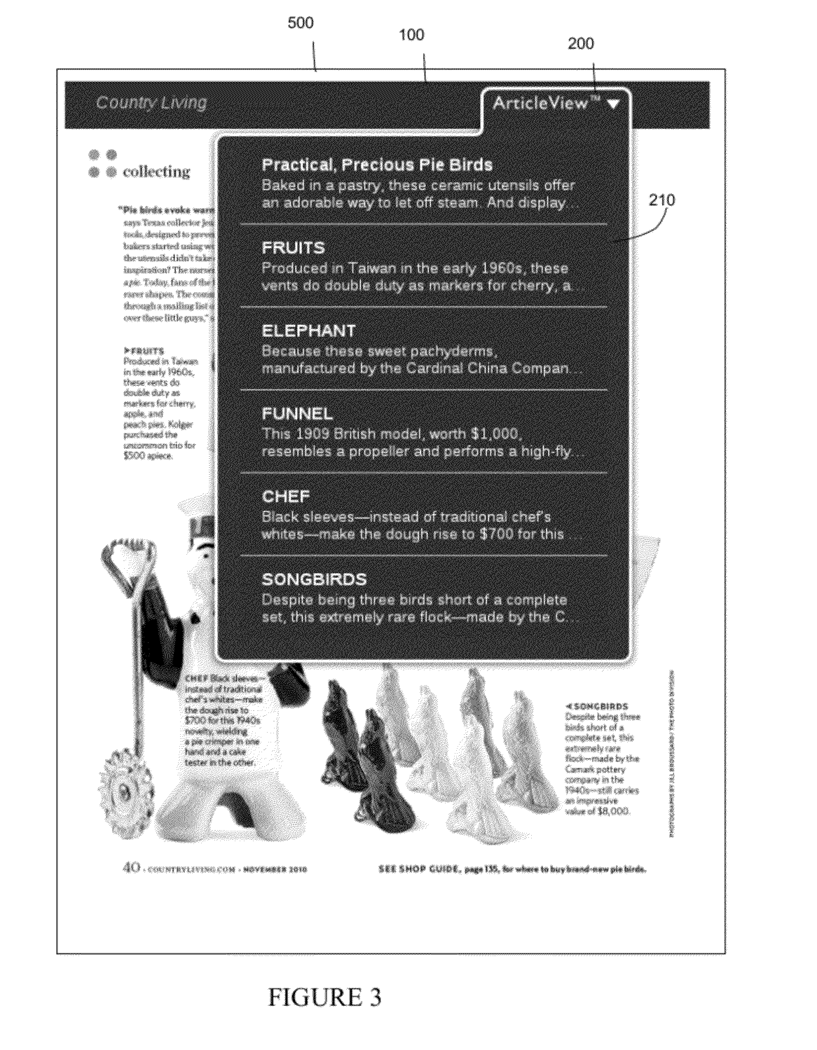

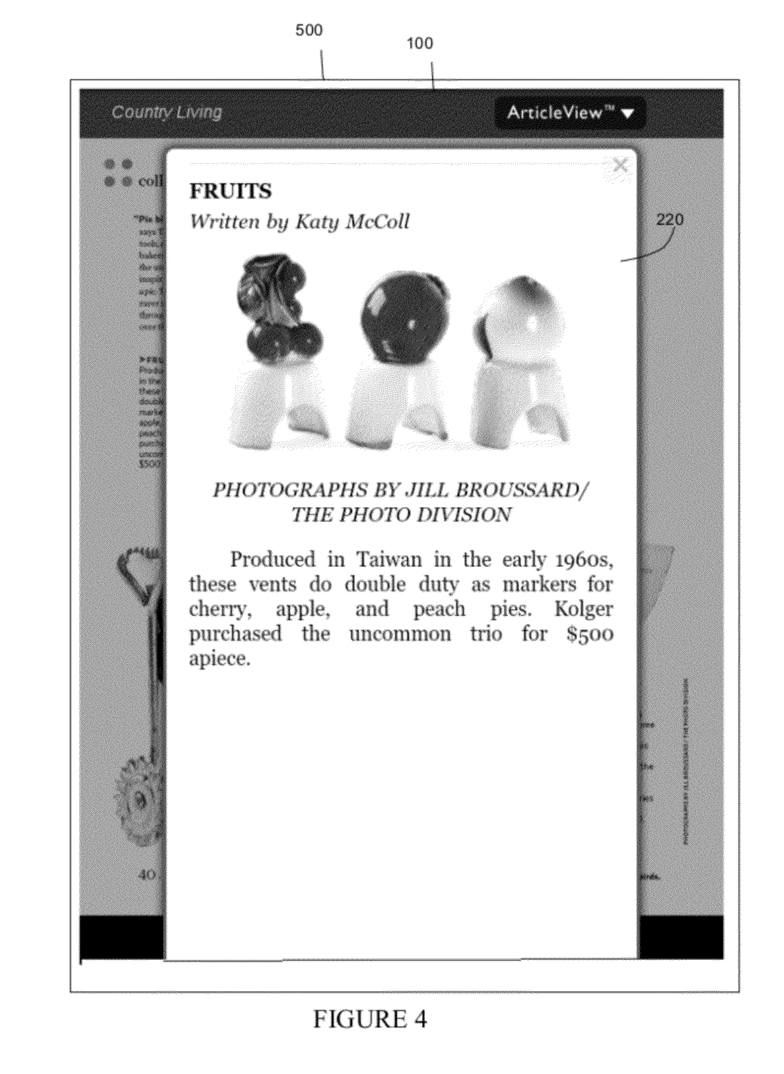

The present invention allows a user to navigate the periodical from text article to text article within ArticleView™. This feature is illustrated in FIG. 3. If the user desires to navigate through articles, rather than page by page in the replica view, the user taps on the 200 which presents a drop down menu of the articles in the publication. The articles within a periodical are logically linked to each other in the data describing the periodical and the individual articles. When navigating between articles in ArticleView™, the replica page image in the background is linked to the text article and changes when the user navigates to another text article in ArticleView if that page is found in the replica view on a different page. For example, if the user wants to the read the “Fruits” article 210, she taps on the article 210 in the drop down menu 200, and that article 220 is brought up in ArticleView™ as illustrated in FIG. 4.

This feature of the present invention allows a user to navigate and read a magazine without ever leaving the ArticleView™ experience. The user is able to navigate between using articles using conventional navigation methods, e.g., a right to left swipe advances to the next article down, a left to right swipe goes to the previous article.

In addition to being able to access the text-only versions articles in ArticleView™ from the replica view, the present invention allows the user to directly link to either the replica page or the ArticleView™ page from the Table of Contents, TOC, for the periodical. This feature optimizes the reading and navigation experience for the user by allowing them to control what reading experience they would like per individual content piece in a magazines TOC. In one embodiment of the present invention, if the user taps on the title of the article in the TOC, she is brought to the page in the replica view of the periodical containing the article. If the user taps on the brief text description of the article contained in the TOC, she initiates the text-only version of the article in ArticleView™.

The present invention further provide for customization of the format of the text in the ArticleView™. The user can customize the display of the text shown in the ArticleView™ with respect to font, type size, background, margin and line spacing. Once the user finds the settings for viewing that she prefers, she can save these settings. The reader of the present invention will subsequently apply these customized preferences across all periodicals that the user reads using the reader of the present invention. This feature of the present invention provides a highly personalized and therefore more enjoyable reading experience and allows for this personalized experience to follow the user across all periodicals.

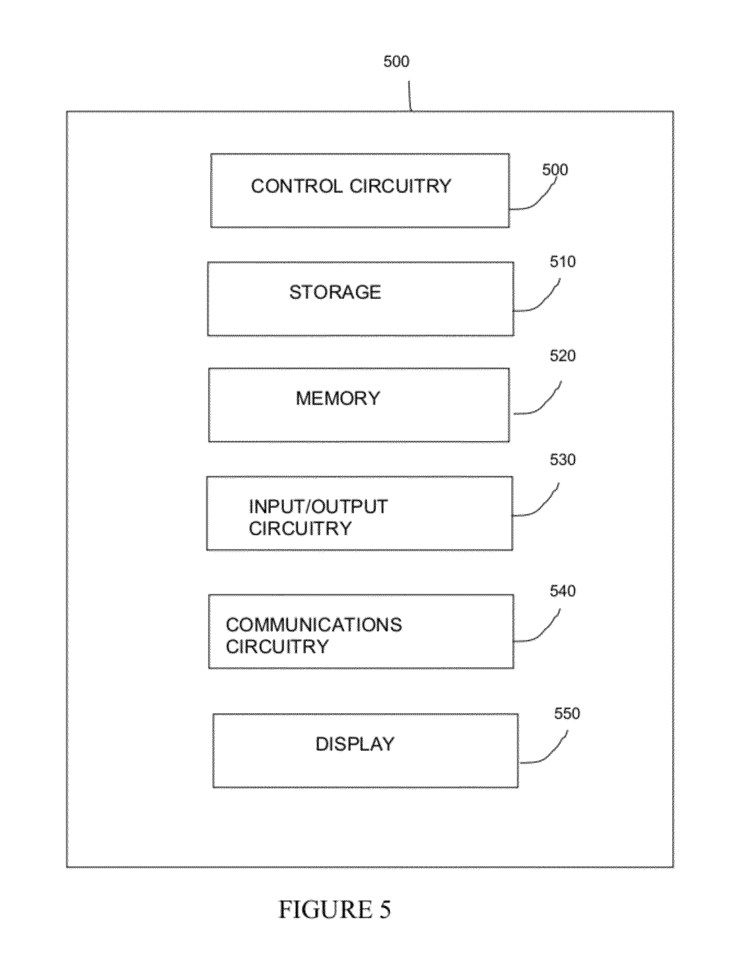

FIG. 5 illustrates an exemplary device 500. As appreciated by those skilled the art, the device 500 can take many forms capable of operating the present invention. As previously described, in a preferred embodiment the device 500 is a mobile electronic device, and in an even more preferred embodiment device 500 is an electronic reader device. Electronic device 500 can include control circuitry 500, storage 510, memory 520, input/output, I/O, circuitry 530, communications circuitry 540, and display 550. In some embodiments, one or more of the components of electronic device 500 can be combined or omitted, e.g., storage 510 and memory 520 may be combined. As appreciated by those skilled in the art, electronic device 500 can include other components not combined or included in those shown in FIG. 5, e.g., a power supply such as a battery, an input mechanism, etc.

Electronic device 500 can include any suitable type of electronic device. For example, electronic device 500 can include a portable electronic device that the user may hold in his or her hand, such as a digital media player, a personal e-mail device, a personal data assistant, PDA, a cellular telephone, a handheld gaming device, a tablet device or an eBook reader. As another example, electronic device 500 can include a larger portable electronic device, such as a laptop computer. As yet another example, electronic device 500 can include a substantially fixed electronic device, such as a desktop computer.

Control circuitry 500 can include any processing circuitry or processor operative to control the operations and performance of electronic device 500. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 includes orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 500 as a whole. The orientation data is then fed to the control circuitry 500 which control an orientation sensing application. The orientation sensing application controls the graphical user interface, GUI, which drives the display 550 to present the GUI for the desired mode.

Storage 510 can include, for example, one or more storage mediums including a hard-drive, solid state drive, flash memory, permanent memory such as ROM, any other suitable type of storage component, or any combination thereof. Storage 510 can store, for example, media content, e.g., eBooks, music and video files, application data, e.g., software for implementing functions on electronic device 500, firmware, user preference information data, e.g., content preferences, authentication information, e.g., libraries of data associated with authorized users, transaction information data, e.g., information such as credit card information, wireless connection information data, e.g., information that can enable electronic device 500 to establish a wireless connection, subscription information data, e.g., information that keeps track of podcasts or television shows or other media a user subscribes to, contact information data, e.g., telephone numbers and email addresses, calendar information data, and any other suitable data or any combination thereof.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 500. Although I/O circuitry 530 is illustrated in FIG. 5 as a single component of electronic device 500, several instances of I/O circuitry 530 can be included in electronic device 500.

Electronic device 500 can include any suitable interface or component for allowing a user to provide inputs to I/O circuitry 530. For example, electronic device 500 can include any suitable input mechanism, such as a button, keypad, dial, a click wheel, or a touch screen, e.g., display 550. In some embodiments, electronic device 500 can include a capacitive sensing mechanism, or a multi-touch capacitive sensing mechanism.

In some embodiments, electronic device 500 can include specialized output circuitry associated with output devices such as, for example, one or more audio outputs. The audio output can include one or more speakers, e.g., mono or stereo speakers, built into electronic device 500, or an audio component that is remotely coupled to electronic device 500, e.g., a headset, headphones or earbuds that can be coupled to device 500 with a wire or wirelessly.

Display 550 includes the display and display circuitry for providing a display visible to the user. For example, the display circuitry can include a screen, e.g., an LCD screen, that is incorporated in electronics device 500. In some embodiments, the display circuitry can include a coder/decoder, Codec, to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 500, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 500 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 500 can include one more instances of communications circuitry 540 for simultaneously performing several communications operations using different communications networks, although only one is shown in FIG. 5 to avoid overcomplicating the drawing. For example, electronic device 500 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 500 can be coupled to a host device such as digital content control server for data transfers, synching the communications device, software or firmware updates, providing performance information to a remote source, e.g., providing riding characteristics to a remote server, or performing any other suitable operation that can require electronic device 500 to be coupled to a host device. Several electronic devices 500 can be coupled to a single host device using the host device as a server. Alternatively or additionally, electronic device 500 can be coupled to several host devices, e.g., for each of the plurality of the host devices to serve as a backup for data stored in electronic device 500.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. An electronic publication stored on a tangible computer medium, the electronic publication comprising:
images of pages contained in the electronic publication;
text of articles contained in the electronic publication; and
a map that maps the text of articles to the images of the pages.

2. The electronic publication according to claim 1, further comprising:
publication metadata;
a manifest; and
a spine.

3. The electronic publication according to claim 2, wherein the images are the top level in the spine.

4. The electronic publication according to claim 2, wherein the articles are the top level in the spine.

5. The electronic publication according to claim 1, wherein the map is bidirectional from the images to the articles and the articles to the images.

6. The electronic publication according to claim 1, wherein the text of the articles are XHTML.

7. The electronic publication according to claim 1, wherein the text of the articles includes image elements.

8. The electronic publication according to claim 1, wherein the map comprises spatial information describing a location on a page image where articles reside.

9. A method of creating an electronic publication comprising:
creating images of pages contained in the electronic publication;
extracting text of articles contained in the electronic publication;
creating files containing the text of articles; and
creating a map that maps the text of articles to the images of the pages.

10. The method according to claim 9, further comprising:
creating publication metadata;
creating a manifest; and
creating a spine.

11. The method according to claim 10, further comprising:
assigning the images as the top level in the spine.

12. The method according to claim 10, further comprising:
assigning the articles as the top level in the spine.

13. The method according to claim 9, wherein the act of map creating the map further comprises creating the map as bidirectional from the images to the articles and from the articles to the images.

14. The method according to claim 9, wherein the act of creating the files further comprises creating the files as XHTML files.

15. The method according to claim 1, wherein the act of creating the files further comprises including image elements in the files.

16. The method according to claim 1, wherein the act of creating the map further comprises including spatial information describing a location on a page image where articles reside.

17. A method of reading an electronic publication comprising:
displaying an image of a page of the electronic publication;
receiving input from a user selecting a text portion on the page;
displaying the text portion in a window separate from the displayed image of the page.

18. The method according to claim 17, wherein the text portion corresponds to an article on the image of the page, the method further comprising displaying all of the text of the article in the window.

19. The method according to claim 18, further comprising scrolling the text in the window.

20. The method according to claim 17, further comprising:
displaying an article view control;
receiving input from a user selecting the article view control; and
displaying a drop down menu listing all articles on the image of the page.

21. The method according to claim 20, further comprising:
receiving input from a user selecting an article in the drop down menu; and
displaying text of the selected article in the window separate from the image of the page.

22. The method according to claim 17, further comprising:
displaying a menu listing all articles in the electronic publication;
receiving input from a user selecting an article in the drop down menu; and
displaying text of the selected article in the separate window.

23. The method according to claim 22, further comprising:
displaying an image of the page corresponding to the selected article; and
displaying the window on top of the image of the page corresponding to the selected article.
